(19) United States
(12) Patent Application Publication
(10) Pub. No.: US 2003/0119537 A1
(43) Pub. Date: Jun. 26, 2003

(54) Wireless network

(75) Inventor: Wassim Haddad, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/323,809

(22) Filed: Dec. 20, 2002

(30) Foreign Application Priority Data
Dec. 20, 2001 (GB) 0130616.6

(51) Int. Cl. H04B 5/00; H04B 7/00; H04Q 7/20

(52) U.S. Cl. 455/517; 455/519; 455/41

(57) ABSTRACT

A method of searching for data upon a plurality of mobile network elements (A-D) within a first, ad hoc, wireless network (9) comprises the steps of:

i) providing at least first and second network elements (A,B) having respective wireless transceivers (5) therein;

ii) transmitting a request for data by the first network element (A) via its wireless transceiver (5);

iii) receiving a signal containing the request for data by the second network element (B) via its wireless transceiver (5);

iv) determining whether the second network element (B) has the requested data thereupon; and

v) transmitting

(a) a confirmation signal from the second network element (B) if the second network element (B) has access to the requested data; or

(b) a further request for the data by the second network element (B) if it does not have access to the requested data.

### FIELD OF THE INVENTION

The present invention relates to a wireless network, and in particular to a network comprising a plurality of communication devices which are able to communicate with each other by way of short-range telecommunication signals.

### BACKGROUND OF THE INVENTION

Personal Digital Assistants (PDA's) are becoming more popular. Such PDA's and other small data processing devices provide highly portable devices that can be used to process data anywhere in which a user is situated. Such data processing devices are optionally fitted with short range communication mechanisms allowing them to communicate over short distances with other devices, which may be compatible similar data processing devices. These communication mechanisms may be in addition to long range communication mechanisms which allow the device to connect to public telephone networks, etc. Known short-range communication mechanisms include Infra Red (IR) links, IEEE 802.11b (WIFI) networks, Bluetooth connections, or the like.

Such short range communication mechanisms provide a convenient way of linking two such data processing devices together, to provide data transfer therebetween.

### SUMMARY OF THE INVENTION

According to a first aspect of the present invention there is provided a method of searching for data upon a plurality of mobile network elements within a first, ad hoc, wireless network comprising the steps of:

i) providing at least first and second network elements having respective wireless transceivers therein;

ii) transmitting a request for data by the first network element via its wireless transceiver;

iii) receiving a signal containing the request for data by the second network element via its wireless transceiver;

iv) determining whether the second network element has the requested data thereupon; and

v) transmitting

(a) a confirmation signal from the second network element if the second network element has access to the requested data; or

(b) a further request for the data by the second network element if it does not have access to the requested data.

Thus, a request for data can be propagated across an ad hoc wireless network, for example a Piconet, and each mobile device within the ad hoc network can be polled to see if it has data requested by another device. The request may ‘ripple’ across the network thereby obviating the necessity for routing equipment associated with conventional network architectures.

The method may include establishing a connection between the first network elements that has received a signal containing the request for data and has the requested data stored thereupon. The method may include connecting first and second network elements via a plurality of wireless connections between a plurality of network elements. The method may include transferring the requested data between the further network element and the first network element via the plurality of network elements. The method may include providing the wireless connections between the plurality of network elements in the form of any one, or combination, of the following: IEEE802.11, Bluetooth, Hiperlan. Alternatively, the method may include connecting both the first and further network elements to a wireless local area network (WLAN) or a cellular network and may include transferring data therebetween over the WLAN or cellular network should the second network element be able to supply the requested data.

Thus data can be routed either via the ad hoc network which utilises the ‘ripple’ effect in a deregulated, free, segment of the electromagnetic spectrum to transfer the data back to the requestor device or via a conventional network thus utilising its associated reliability.

The method may include transmitting a confirmation signal by the further network element if it has the requested data stored thereupon. The method may include relaying the confirmation signal via the ad hoc network to the first network element.

The method may include restricting access to some, or all, data that is stored upon at least one of the mobile network elements. This allows a user to prevent access to sensitive or personal data and can also be used to prevent the accessing of copyright data.

The method may include accessing a second network, typically the Internet, by the first network element if the requested data cannot be found within the ad hoc network after transmission of the request for data by the first network element. The method may include connecting to the second network via any one of the following: cellular telecommunications link (WAP, GPRS, UMTS), infra red link (IEEE802.11, Bluetooth, Hiperlan). The method may include providing an access point for infra red connections to the second network. The method may include paying for access to data stored upon the second network.

The method may include receiving a signal at the first network element that is an indicia of some, or all, of the data available from one of the plurality of network elements. The method may include receiving a plurality of such signals from some, or all, of the plurality of network elements. The method may include collating said indicia into a database, that may be displayed upon a screen of the first network element and from which a user may select data to be requested. Alternatively, or additionally, the indicia may simply be displayed upon a screen. This allows a device to build up a database of information/data that it can download from within the ad hoc network as it passes therethrough. For example, a shopping mall advertisement detailing special offers can be broadcast from access points around the mall and a user of the device can select the best price for an MP3 file, etc.

The method may include imposing at least one of the following conditions and/or restrictions upon the request: file type, file size, expiration time limit, maximum download time, price

The method may include incrementing a counter associated with each received signal containing the request for data each time the request is re-transmitted and may include terminating a request upon the counter exceeding a predetermined value. The method may include emitting a signal to a device which determines the number of further permissible relays of the request from any one network element to any other network. Thus, the maximum number of network hops before a request for data is terminated can be set.

The method may include radiating the request for data outward from the first network element.

According to a second aspect of the present invention there is provided a mobile network element comprising processing means, data storage means, a wireless transceiver, the transceiver arranged to transmit a signal corresponding to the request for data and arranged to receive a confirmation signal from a remote network element that has the requested data stored thereupon.

The mobile network element may form part of an ad-hoc wireless network, for example a piconet.

The transceiver may be arranged to poll one or more proximal network elements via a wireless connection and may be arranged to receive responses from suitably configured network elements of said one, or more, proximal network elements. The processing means may be arranged to determine whether the, or each, proximal network elements that are configured to respond to said polling are suitable for establishing a connection thereto.

The processing means may be arranged to discriminate between those devices that can service a request for data, for example PDA's, PC's etc., and those that cannot, for example a printer.

The mobile network element may be arranged to receive a signal that has been routed via at least one other network element is an ad-hoc network from a further network element that is beyond the range of a direct wireless connection with the mobile network element.

The processing means may be arranged to attach a condition upon the request for data, for example, file type, file size, download time, time before expiry, upper cost limit (either monetary or in bandwidth), processing load on a processing means of a network element.

The request may contain an identification associated with the first network element, possibly a network address and/or a unique identity. The request may include a data destination identifier which may, or may not, be the same as the identification and/or unique identity associated with the first network element.

The processing means may be arranged to determine that data requires requesting, for example by running diagnostics or by consulting a database of desired data, and may be arranged to request the data. Alternatively, the mobile network element may include input means via which a user may input the request for data.

The mobile network element may be any one of the following: personal digital assistant (PDA), mobile telephone, lap top (or palm top) computer.

The mobile network element may be arranged to receive a signal containing the requested data via a cellular network or WLAN.

According to a third aspect of the present invention there is provided an ad hoc wireless network comprising a plurality of mobile network elements, each of the mobile network elements being in wireless communication with at least one other of the mobile network elements and arranged such that a request for data transmitted by a first of the mobile network elements is received by at least a second of the mobile network elements, the second mobile network element being arranged to either confirm to the first mobile network element that it has the requested data or to transmit a further request for the data.

The network may comprise a third network element arranged to receive the further request for data. The third network element may be arranged to either transmit a confirmatory signal that it has the requested data or to transmit a yet further request for the data. The second network element may be arranged to relay a confirmatory signal that it receives to the first network element. Thus, the network comprises a plurality of devices which are able to relay a request for information in a ‘step-by-step’ manner to devices that are beyond the wireless connections range of the device from which the request for data originated.

The confirmation, or confirmatory signal, may include, or may be, the requested data.

The network may be arranged such that when a network element, that is able to satisfy the request for data, is out of direct wireless communication range of the first network element the data is relayed to the first network element via at least one other network element.

Each of the network elements may be any one of the following: PDA, mobile telephone, laptop (or palm top) computer, watch or any other suitable device.

The network may, at least temporarily, include an access point, which may be arranged to transmit a signal relating to data that is available from either of the access point, or a data serving resource associated with the access point.

The network elements may be in wireless communication with each other via connections using any one or combination, of the following standards: Hiperlan, IEEE 802.11 (including any of the variations of this protocol), Bluetooth.

The network may be arranged to receive data from either of a cellular network or a WLAN via a suitably configured network element. This allows data to enter the network from a remote source, for example, if a device having received the request for data and having the requested data leaves the ad-hoc network it can transmit the data onto the network via a cellular of WLAN connection.

According to a fourth aspect of the invention there is provided a data carrier which is provided with instructions for controlling a data processor of a communication device and running the instructions causes the communication device to operate in accordance with the communication device as set out by the second aspect of the present invention.

Such a data carrier includes magnetic data carriers such as tapes, optical data carriers such as DVDs and CDs, and firmware stored in a ROM.

According to a fifth aspect of the present invention there is provided a computer readable medium having stored therein instructions for causing a device to execute the method of the first aspect of the present invention.

Such a computer readable medium includes magnetic data carriers such as tapes, optical data carriers such as DVDs and CDs, and firmware stored in a ROM.

According to a sixth aspect of the present invention there is provided a propagated signal for use in a wireless network comprising a request for data from a first network element to be received by a further network element.

According to a seventh aspect of the present invention there is provided a network element arranged to receive a signal in accordance with the sixth aspect of the present invention.

### BRIEF DESCRIPTION OF THE DRAWINGS

The invention will now be described, by way of example only, with reference to the accompanying drawings in which:

FIG. 1 is a schematic representation of a communication device in accordance with an aspect of the present invention;

FIG. 2 is a schematic representation of an ad-hoc network of several mobile devices which communicate with other by way of short-range wireless links;

FIG. 3 is a flow diagram of the steps by which a communication device requests specified data from other devices in the network shown in FIG. 2;

FIG. 4 is a flow diagram of the process by which the maximum permissible number of relays between devices is controlled; and

FIG. 5 schematically shows an example piconet implementing one embodiment of the invention.

### DETAILED DESCRIPTION OF THE DRAWINGS

For the purpose of explanation the devices will be considered to be suitably enabled portable devices such as a mobile telephone, laptop, or palm top, computers or personal digital assistants (PDA's). It will be further understood that the terms network element and communication device are used herein synonymously.

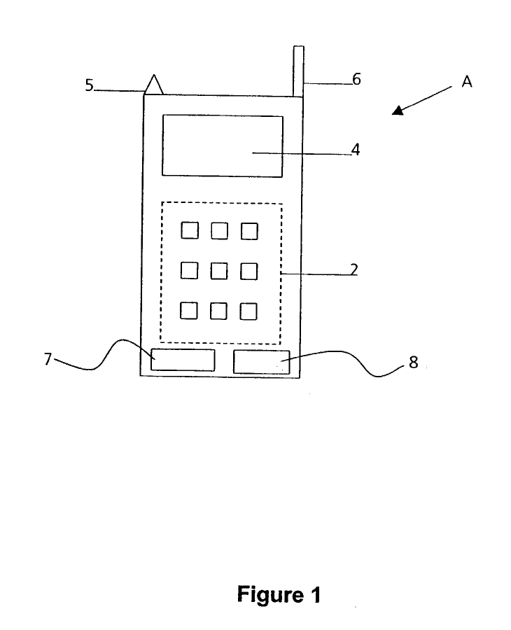

FIG. 1 shows a suitably adapted mobile telephone A which comprises keypad 2, a screen 4, a LAN transceiver 5, a cellular transceiver 6, a data memory 7 and a microprocessor 8. The LAN transceiver 5 allows a user to communicate with other devices which are within approximately a ten metre range. Such devices are enabled to perform such short-range radio communications by way of a suitable specification such as Bluetooth, IEEE802.11 or Hiperlan.

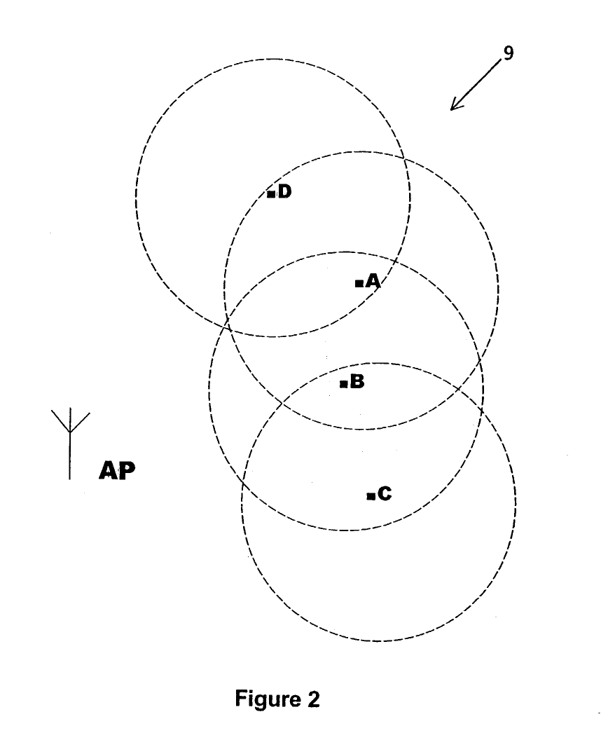

FIG. 2 shows four communication devices A, B, C and D which form a network 9.

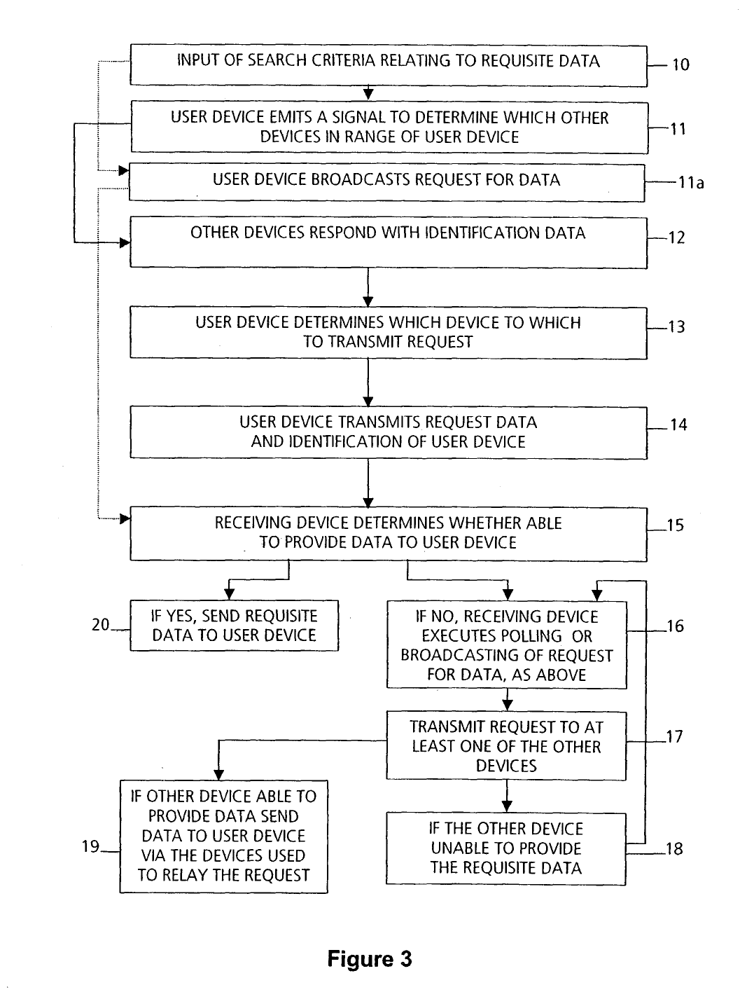

In use the network 9 operates as follows and will be explained initially with reference to FIG. 3. The user of device A requires particular information which he does not have stored on the device, such as for example, a data file relating to a body of text, an MP3 file, flight arrival times or a bus schedule.

The user of A inputs into his device A using a keypad 2 either the name of the file or keywords which are contained in the file or the name of the file (Step 10 of FIG. 3). Alternatively, the microprocessor 8 responds to a flag, typically is an application, that a piece of data is needed and automatically generates a request for the piece of data. The user then causes the device A to emit a signal to determine which devices are in range of A which extends over a radius of approximately ten metres (Step 11 of FIG. 2).

The devices B and D which are within this radius (see FIG. 2 and the broken circle around it) receive the signal. The devices B and D each respond to A with a signal which is representative of their respective identification data (Step 12 of FIG. 3). On receiving these response signals from B and D, A determines to which of B and D a signal is to be sent which is representative of a request for the particular data file which user A requires (Step 13 of FIG. 2).

The device A may determine which device to send the request in a number of ways, including selecting between B and D at random, sending the request to the first out of B and D to respond. If the identification data includes data which relates to the characteristics of B and D, then A can determine which device is most or least suitable to handle the request. Such characteristics data may include, for example, the fact that a device which has received the polling signal may not have any data which it is willing to share, and so it would be pointless to send a request to such a device.

Alternatively, A may broadcast the request for data directly, without first polling the surrounding devices. (Step 11a of FIG. 3). For the purpose of explanation it is assumed that device B is chosen to receive the request for data. Device A then emits a signal which is representative of the information input by the user to be used to attempt to locate the file, the identification data of device A, and identification data of device B so that it is indicated that device B has been chosen (Step 14 of FIG. 3).

On receiving the request signal the device B initially determines which of the data files it has stored are shareable, and then proceeds to search the data files for a match to the request of the user of device A. (Step 15 of FIG. 3). Alternatively, the device B simply searches all data files stored or only those without a ‘non-shareable’ flag.

If the device B is unable to fulfil the request either because the data requested is stored but not available for sharing, or the device B does not have the file then the device B proceeds to emit a polling signal in the same manner as device A did initially. (Step 16 of FIG. 3).

The device B receives a response signal from only one device, device C. The device B then proceeds to emit to the device C the data which device sent to device B, i.e. the search criteria for the requisite information, identification data of device A, and, in addition, identification data of the device B. (Step 17 of FIG. 3).

The device C then proceeds to search the data memory of said device C and determine whether the device C has the data file which the device A has requested.

If the device C has the requisite information then a signal representative of copy of the file, the identification data of device B, and the identification data of device A is sent to device B (Step 19 of FIG. 3). The inclusion of the identification data in the signal emitted by C of device B will ensure that the device B accepts the signal and temporarily stores the requisite data file and the identification data of device A. The device B is then operative to emit a signal which is representative of the data file and of the identification data of device A. Again, the inclusion of the identification data of device A acts as an indicator that the signal is for the device A.

If device C had been able to provide the requisite data then Step 18 of FIG. 3 would be executed. If device B had been able to provide the requisite data then Step 20 would have been executed.

Thus, the requisite data file has been obtained by the user of the device A by means of an ‘ad-hoc’ piconet. It is envisaged that, advantageously, data may be obtained in this way at minimal or effectively no financial cost. It is known to obtain data using a long-range cellular telecommunications network, for example by using Wireless Application Protocol. (WAP), however there will be associated monetary connection time costs. Such costs do not arise when using the network and method described hereinbefore.

However, it is envisaged that should the request for data not be able to be fulfilled by the network and method described hereinbefore the user of a device could access the data via a cellular or WLAN connection.

Requisite data may potentially be obtained from a device to which a request may be relayed over the short-range links.

It is desirable that the user of the device be able to control the extent of the search. To this end the user of device A is able to input at the time of initiating the search the maximum number of times he wishes the request to be relayed, a particular file type (e.g. Word™), a maximum file size, or maximum download times.

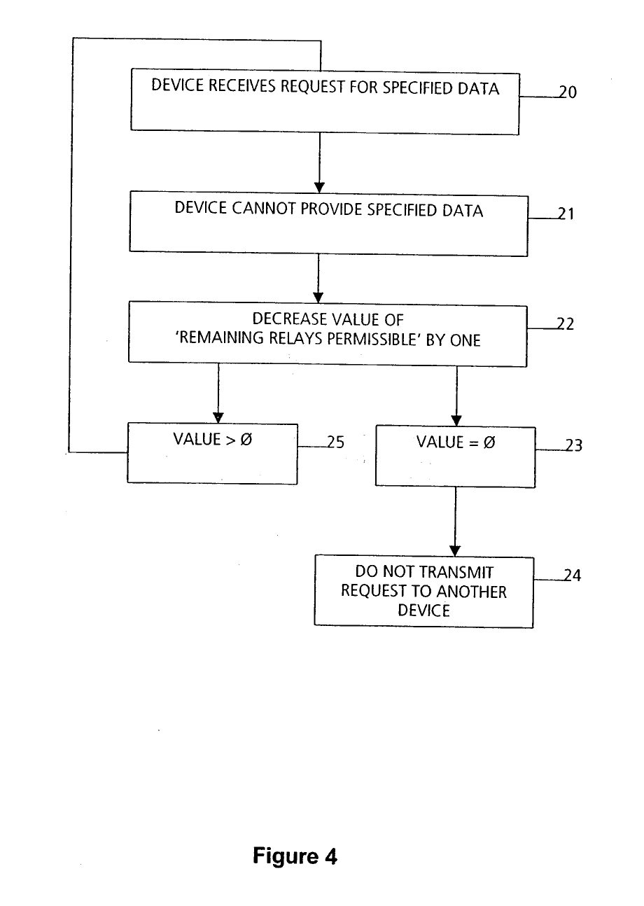

FIG. 3 illustrates one way of achieving this in which the device A emits a signal to device B (or whichever device has been chosen device A) which includes data relating to, for example, the maximum number of potential devices to which the request may be relayed. When the device B and whichever other intermediary devices emit the request to another device the signal emitted includes the remaining value of the maximum permissible value. This value is decreased by one by the device which has received the request signal but is unable to provide the requested data. (Steps 20, 21 and 22 of FIG. 4). If when the remaining value 13 is decreased by one zero is obtained, then the device does not attempt to locate another device to which the request can be sent (Step 23 of FIG. 4). In such a case this fact may be relayed back to the device A. If the remaining value, when decreased by an ‘unobliging device’, is greater than zero the request is permitted to be forwarded to another device (Step 25 of FIG. 4).

In the situation where the maximum permissible number of relays has occurred, the user device A is configured to wait a predetermined length of time from transmitting the request to device B, after which if the device A has not received a signal which is representative of the requisite data or a signal representative of whether the maximum permissible number of relays has occurred, then the device may be programmed by the user to either try again (and potentially locate a device that has just entered into the piconet which has the requisite data) or prompt the user to decide whether he wants to try again. The device A may be configured to allow the user to request the requisite data using a signal which is emitted by LAN transceiver aerial 5 via an access point (AP) to a Wireless Local Area Network or WLAN over a long-range cellular telecommunications network via the cellular transceiver 6. However, accessing such a WLAN is likely to result in the user having to pay for the material required. If the AP is within the shortrange capabilities of the device A then the WLAN can be so contacted.

If the desired data can only be obtained within the piconet by payment, the member device can connect to the WLAN in order to compare costs of data access and choose the lowest cost, in terms of bandwidth, money, or both.

At the time of initiating the request the user may be able to specify whether he wants the specified data on the proviso that the specified data is provided free of charge and/or at a charge of less than a predetermined value. A device receiving such a request would then determine whether the specified data could be provided with such a proviso on the basis of information stored in the receiving device.

In an alternative embodiment the maximum number of relays is limited by the device A emitting a signal which is representative of the maximum number of permissible relays and a counter. Each time the request is relayed the counter is incremented, and when a device which receives the request determines that the counter value is the same as the maximum value, that device will not relay the request to another device.

In another alternative embodiment of the invention the device A is configured to broadcast the request signal to a plurality of devices which are within range. In such an embodiment the maximum number of relays input by the user would relate to maximum number of times a request is to be relayed in a path of particular devices (since if the devices which the device A relays the request to are unable to provide the data they will then relay the request to further devices in range and so on).

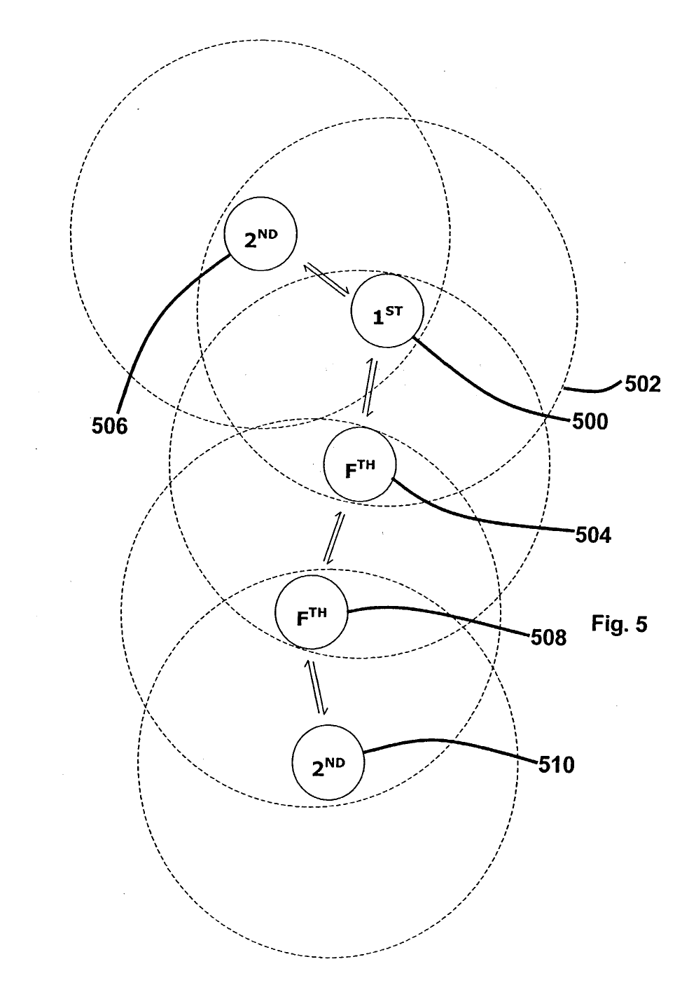

An example piconet is shown in FIG. 5, which shows a first processing device 500 capable of communicating with other processing devices via a wireless medium (in this embodiment via Bluetooth™). The user of the first processing device 500 wishes to obtain specified data, in this case an MP3 track entitled “specified data”.

The extent to which the Bluetooth radio network extends is shown by the circle 502 centred on the first processing device 500. It can be seen that two processing devices 504,506 are within range and can therefore communicate with the first processing device 500. Likewise, a processing device 508 is in range, and can therefore communicate with, processing device 504. And further, a processing device 510 is in range of, and therefore can communicate with, processing device 508.

Two of the above referred to processing devices 506,510 have the MP3 track “specified data” thereon and these will hereinafter be referred to as second processing devices.

The first processing device 500 initiates the search for “specified data” by radiating a request for that data. This request is received by the further processing device 504 and the second processing device 506. Firstly, taking the further processing device 504, which determines that it does not have access to “specified data”. Therefore, the further processing device 506 repeats the request transmission for “specified data”, which is now received by further processing device 508 (which is out of range of the first processing device 500).

Having access to the specified data may mean that the data is held on the processing device, or it may mean that the processing device has a connection to a storage means that has the specified data thereon.

The further processing device 508 determines that it does not have access to “specified data” and again makes a repeat request for said specified data. This repeated request is now received by the second processing device 510 which holds a copy of “specified data”. The second processing device 510 emits a confirmation transmission which is received by the further processing device 508. The device 508 relays, by re-transmission, this confirmation transmission to the further processing device 504 which then relays, by re-transmission, the transmission back to the first processing device 500. The first processing device 500 is now aware that the second processing device 510 holds a copy of “specified data” although the second processing device 510 is out of range of the first processing device 500.

The second processing device 506 also has the “specified data” track thereon and therefore, when it received the request for the “specified data” from the first processing device 500 it determines that it has access to the specified data and responds with a confirmation transmission. The first processing device 500 therefore becomes aware that “specified data” is available from the second processing device 506.

Therefore, the first processing device 500 locates the track “specified data” on two devices. The first processing device 500 can then initiate a data transfer as it sees fit. The selected source may depend on factors such as the number of processing devices through which the data may pass, the cost of data levied by the device on which it is held, the bandwidth of the connections between the devices, the loading on the processing devices through which data must pass, etc.

The specification above refers to both a mobile network element and a processing device. Generally, these terms will be interchangeable and may refer to the same article.

1. A method of searching for specified data upon a plurality of processing devices within an ad hoc wireless network comprising the steps of:
i) providing a first processing device and at least one second processing devices each having respective wireless transceivers therein;
ii) transmitting a request for said specified data by said first processing device via said wireless transceiver;
iii) receiving said request for said specified data on said second processing device via said wireless transceiver;
iv) causing said second processing device to determine whether it has access to said requested specified data;
v) causing said second processing device to determine which transmission it is appropriate to send from at least one of
(a) a confirmation transmission if said second processing device has access to said requested specified data; and
(b) a repeat request transmission for said specified data if said second processing device does not have access to said specified requested data; and
vi) causing said second processing device to transmit said transmission that it determines should be sent

2. The method of claim 1 including connecting said first processing device and said second processing device via a plurality of wireless connections established through at least one further processing device.

3. The method of claim 2 including transferring said requested specified data between said first processing device and said second processing device via said at least one further processing device.

4. The method of claim 1 including connecting both the first processing device and the second processing device to one of a wireless local area network (WLAN) and a cellular telephone network and transferring said requested specified data therebetween over one of said WLAN and said cellular telephone network should said second processing device be able to supply said requested specified data.

5. The method of claim 1 including restricting access to at least some data that is stored upon said second processing device.

6. The method of claim 2 in including causing said at least one further processing device to re-transmit said confirmation transmission that said second processing device has access to said requested data should said at least one further processing device receive such a transmission.

7. The method of claim 1 including causing said first processing device to access a second network, different from said ad hoc network, if said requested specified data cannot be found within said ad hoc network after the transmission of said request for said specified data by said first processing device.

8. The method of claim 1 including causing said first processing device to store said confirmation transmission that at least one said second processing device has access to said requested specified data; and further selecting from which said second processing device said requested specified data should be obtained.

9. The method of claim 1 including incrementing a counter associated with said transmitted request for said specified data each time a repeat request for said specified data is made and terminating transmission of said repeat request upon said counter exceeding a predetermined value.

10. The method of claim 1 including radiating said request for specified data outward from said first processing device.

11. A processing device comprising processing means, data storage means, a wireless transceiver, the transceiver arranged to transmit a signal corresponding to a request for specified data and arranged to receive a confirmation signal from a remote processing device that has the requested data stored thereupon.

12. A processing device according to claim 11 which is arranged to receive requests for specified data and to determine whether said processing device has access to said specified data and if said device has access to said specified data to generate and transmit via said transceiver a confirmation signal.

13. A processing device according to claim 12 in which if said device does not have access to said specified data it is arranged to generate and transmit via said transceiver a repeat request transmission for said specified data.

14. A processing device according to claim 11 wherein the transceiver is arranged to poll one or more proximal processing devices via a wireless connection and is arranged to receive responses from suitably configured processing devices of said one or more processing devices.

15. A processing device according to claim 11 wherein said processing device is arranged to receive a signal that has been routed via at least one other processing device in an ad-hoc network from a further processing device that is beyond the range of a direct wireless connection with said processing device.

16. A processing device according to claim 11 wherein said processing means is arranged to attach at least one of the following conditions to said request for specified data: file type, file size, download time, time before expiry, upper cost limit.

17. An ad hoc wireless network comprising a plurality of processing devices, each of said processing devices being in wireless communication with at least one other of said processing devices and arranged such that a request for data transmitted by a first of said processing devices is received by at least a second said processing device, said second processing device being arranged to determine at least one of whether it is appropriate to generate a confirmation transmission to said first processing device that it has the requested specified data and whether it is appropriate to transmit a repeat request for said specified data; and further being arranged to transmit said transmission that it determined should be sent.

18. A network according to claim 17 wherein said network comprises a further processing device arranged to receive said repeat request for data and arranged to either generate and transmit a confirmation transmission that it has the requested specified data or to transmit a repeat request for the specified data.

19. A network according to claim 18 wherein said further processing device is arranged to relay a confirmation transmission that it receives.

20. A network according to claim 17 wherein said confirmation transmission includes, or is, said requested specified data.

21. A network according to claim 17 wherein said network is arranged such that when a processing device, that is able to satisfy the request for specified data, is out of direct wireless communication range of said first processing device said specified data is relayed to said first processing device via at least one other processing device.

22. A computer readable medium having stored therein instructions for causing a device to execute the method of claim 1.

23. A data carrier which is provided with instructions for controlling a data processor of a processing device and running the instructions causes the processing device to operate in accordance with the processing device of claim 11.

24. A processing device comprising processing means, a wireless transceiver, the transceiver arranged to transmit a signal corresponding to a request for specified data and arranged to receive a confirmation transmission from a remote processing device that has the requested data stored thereupon, further arranged to receive requests for specified data and to determine whether said processing device has access to said specified data and if said device has access to said specified data to generate and transmit via said transceiver a confirmation signal and further arranged that if said device does not have access to said specified data it is arranged to generate and transmit via said transceiver a repeat request transmission for said specified data.

25. A processing device according to claim 24 in which said confirmation transmission includes said specified data.
